(19) United States
(12) Patent Application Publication
(10) Pub. No.: US 2005/0003886 A1
(43) Pub. Date: Jan. 6, 2005

(54) Gaming machine having a community game with side wagering

(76) Inventors: Allon G. Englman, Chicago, IL (US); Larry J. Pacey, Prospects Heights, IL (US)

Correspondence Address: JENKENS & GILCHRIST, P.C., 225 WEST WASHINGTON, SUITE 2600, CHICAGO, IL, 60606, US

(21) Appl. No.: 10/612,478

(22) Filed: Jul. 2, 2003

(51) Int. Cl. A63F 13/00

(52) U.S. Cl. 463/25; 463/20

(57) ABSTRACT

A gaming system including a plurality of interconnected gaming terminals. A first one of the plurality of interconnected gaming terminals receives a side wager inquiry signal in response to a second one of the plurality of interconnected gaming terminals achieving a special gaming session. The side wager inquiry signal causes a side wager inquiry to be displayed to a player of the first one of the plurality of interconnected gaming terminals.

### FIELD OF THE INVENTION

The present invention relates generally to gaming machines and, more particularly, to a gaming machine and a gaming machine network having an enhanced progressive game that allows players to place side wagers on certain events that occur within the progressive game being played by another gaming machine.

### BACKGROUND OF THE INVENTION

Gaming machines, such as slot machines, video poker machines, and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines.

Consequently, shrewd operators strive to employ the most entertaining and exciting machines available because such machines attract frequent play and, hence, increase profitability to the operator. In the competitive gaming machine industry, there is a continuing need for gaming machine manufacturers to produce new types of games, or enhancements to existing games, which will attract frequent play by enhancing the entertainment value and excitement associated with the game.

One concept that has been successfully employed to enhance the entertainment value of a game is that of a “secondary” or “bonus” game which may be played in conjunction with a “basic” game. The bonus game may comprise any type of game, either similar to or completely different from the basic game, and is entered upon the occurrence of a selected event or outcome of the basic game. Such a bonus game produces a significantly higher level of player excitement than the basic game because it provides a greater expectation of winning than the basic game.

Another concept that has been employed is the use of a progressive jackpot. In the gaming industry, a “progressive” involves the collecting of coin-in data from participating gaming device(s) (e.g., slot machines), contributing a percentage of that coin-in data to a jackpot amount, and awarding that jackpot amount to a player upon the occurrence of a certain jackpot-won event. A jackpot-won event typically occurs when a “progressive winning position” is achieved at a participating gaming device. If the gaming device is a slot machine, a progressive winning position may, for example, correspond to alignment of progressive jackpot reel symbols along a certain pay line. The initial progressive jackpot is a predetermined minimum amount. That jackpot amount, however, progressively increases as players continue to play the gaming machine without winning the jackpot. Further, when several gaming machines are linked together such that several players at several gaming machines compete for the same jackpot, the jackpot progressively increases at a much faster rate, which leads to further player excitement. In existing progressive games, once a player at a first gaming machine enters the progressive game, the players at the other gaming machines are not involved in the progressive game. In other words, the other players do not get the opportunity to participate in the progressive game.

While these player appeal features provide some enhanced excitement relative to other known games, there is a continuing need to develop new features for gaming machines to satisfy the demands of players and operators. Specifically, the current progressive games only provide enhanced excitement to the player invited to play for the jackpot. Thus, there is a need for engaging multiple players after one player enters the progressive game.

### SUMMARY OF THE INVENTION

In accordance with one aspect of the present invention, there is provided a gaming system having a plurality of interconnected gaming terminals. Each of the gaming terminals are capable of conducting wagering games. When one of the gaming machines achieves a special gaming session, for example, a progressive game, the other gaming terminals receive a side wager inquiry signal. A side wager inquiry is then displayed to players of the other gaming terminals. Thus, players who have not won a chance to play for a jackpot are permitted to wager on events within the progressive game played by another player.

In accordance with another aspect of the present invention, there is provided a gaming system including a plurality of gaming terminals that conduct wagering games. Located above and coupled to the plurality of gaming terminals is signage. The signage conducts a progressive wagering game for players at the gaming terminals. A local controller is included in the signage and randomly selects a progressive game outcome. The progressive game outcome is displayed on the signage.

The above summary of the present invention is not intended to represent each embodiment, or every aspect, of the present invention. This is the purpose of the figures and the detailed description which follow.

### BRIEF DESCRIPTION OF THE DRAWINGS

The foregoing and other advantages of the invention will become apparent upon reading the following detailed description and upon reference to the drawings.

FIG. 1 is a perspective view of a video gaming machine according to one embodiment of the present invention.

FIG. 2 is a block diagram of the gaming machine of FIG. 1.

FIG. 3 is a gaming system of interconnected video gaming machines and signage according to one embodiment of the present invention, one gaming machine achieving a progressive game and the other three gaming machines being able to make a side wager on the progressive game.

FIG. 4 is a flowchart describing the operation of the gaming machines and the signage of FIG. 3.

FIG. 5 is an illustration of a progressive game screen which may be implemented on the gaming machine achieving the progressive game at step 62 of FIG. 4.

FIG. 6 is an illustration of a “Build Houses” screen which appears on the video display of the gaming machines able to make a side wager at step 66 in FIG. 4.

FIG. 7 is an illustration of a progressive game play screen which may appear on the video display of the gaming machines able to make a side wager at step 70 of FIG. 4.

FIG. 8 is an illustration of a progressive game play screen which may appear on the video display of the gaming machine achieving the progressive game and the signage of FIG. 3 at step 70 of FIG. 4.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

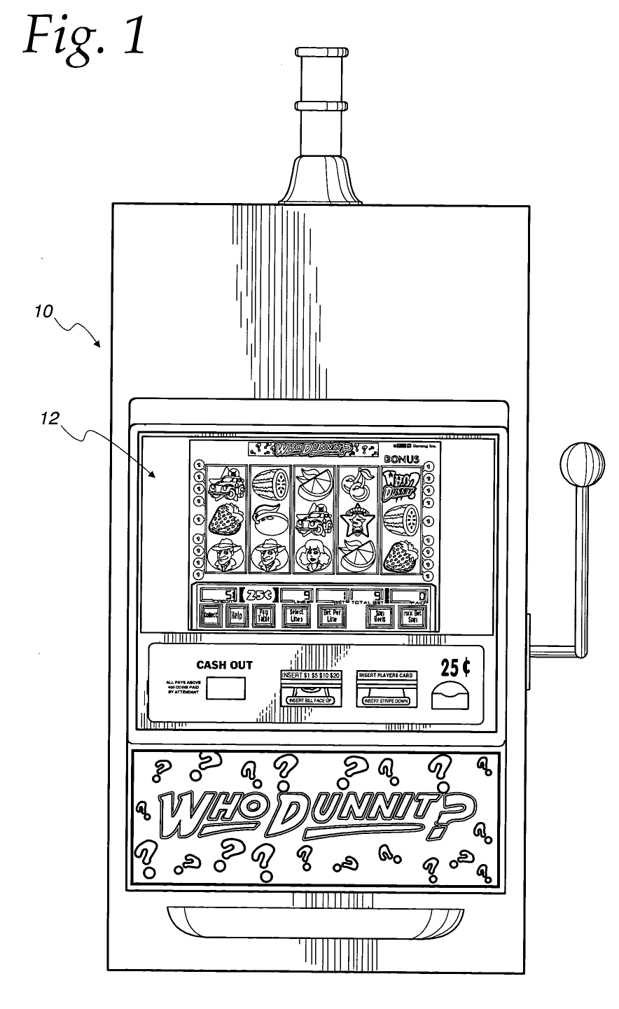

Turning now to the drawings and referring initially to FIG. 1, a video gaming machine 10 is depicted that may be used to implement the enhanced progressive game according to the present invention. The gaming machine 10 includes a video display 12 that may comprise a CRT, LCD, plasma, LED, electro-luminescent display, or generally any type of video display known in the art. In the illustrated embodiment, the gaming machine 10 is an “upright” version in which the video display 12 includes a touch screen and is oriented vertically relative to the player. It will be appreciated, however, that any of several other models of gaming machines are within the scope of the present invention, including, for example, a “slant-top” version in which the video display is slanted at about a 30° angle toward the player, or gaming machines that include mechanical, rather than video, displays.

In one embodiment, the gaming machine 10 is operable to play a game entitled WHO DUNNIT?™ having a mystery theme. The WHO DUNNIT?™ game features a basic game in the form of a slot machine with five simulated spinning reels and a bonus game with selection options directing game activities on the video display 12. Such a gaming machine is disclosed in detail in U.S. Publication No. U.S. 2002/0090990 A1, which is incorporated herein by reference in its entirety. It will be appreciated, however, that the gaming machine 10 may be implemented with games other than the WHO DUNNIT?™ game and/or with several alternative game themes.

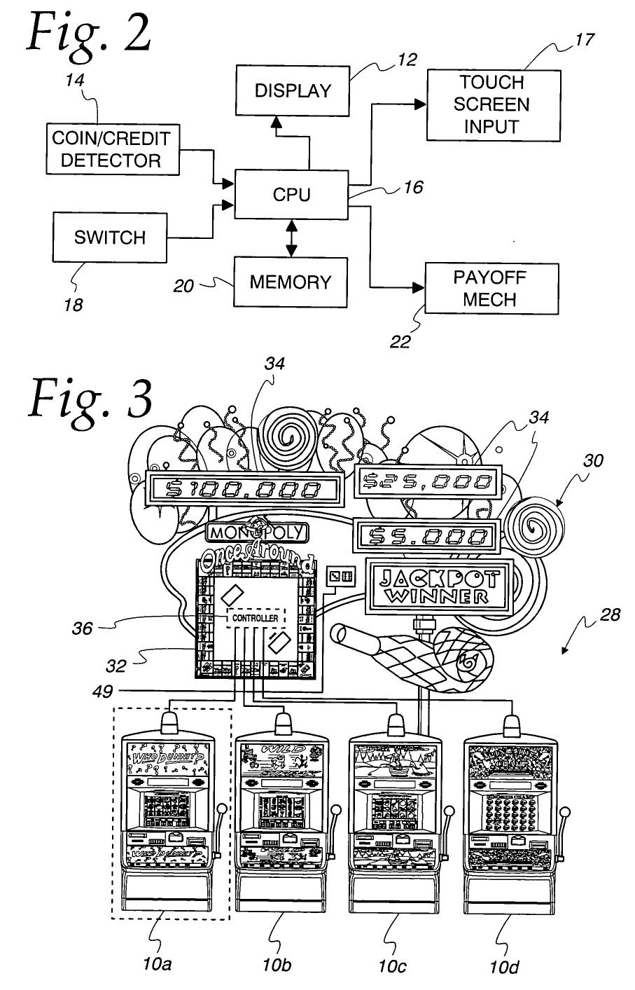

FIG. 2 is a block diagram of a control system suitable for operating the gaming machine 10. Coin/credit detector 14 signals a CPU 16 when a player has inserted a number of coins or played a number of credits. Then, the CPU 16 executes a game program which causes the video display 12 to display the basic game that includes simulated reels with symbols displayed thereon. The player may select the number of paylines to play and the amount to wager via touch screen input keys 17. The basic game commences in response to the player activating a switch 18 in a lever or push button, causing the CPU 16 to set the reels in motion, randomly select a game outcome, and then stop the reels to display symbols corresponding to the pre-selected game outcome. Preferably, certain basic game outcomes cause the CPU 16 to enter a bonus mode, which causes the video display 12 to show a bonus game, as is known in the art.

A system memory 20 stores control software, operational instructions, and data associated with the gaming machine 10. In one embodiment, the system memory 20 comprises a separate read-only memory (ROM) and battery-backed random-access memory (RAM). It will be appreciated, however, that the system memory 20 may be implemented on any of several alternative types of memory structures or may be implemented on a single memory structure. A payoff mechanism 22 is operable in response to instructions from the CPU 16 to award a payoff of coins or credits to the player in response to certain winning outcomes which may occur in the basic game or bonus game. The payoff amounts corresponding to certain combinations of symbols in the basic game are predetermined according to a pay table stored in system memory 20. The payoff amounts corresponding to certain outcomes of the bonus game are also stored in system memory 20.

The gaming machine 10 of FIGS. 1 and 2 is a gaming terminal that receives inputs, randomly selects outputs and displays outputs, as controlled by the internal CPU 16. It will be appreciated, however, that the present invention can be used by gaming terminals controlled by external CPUs.

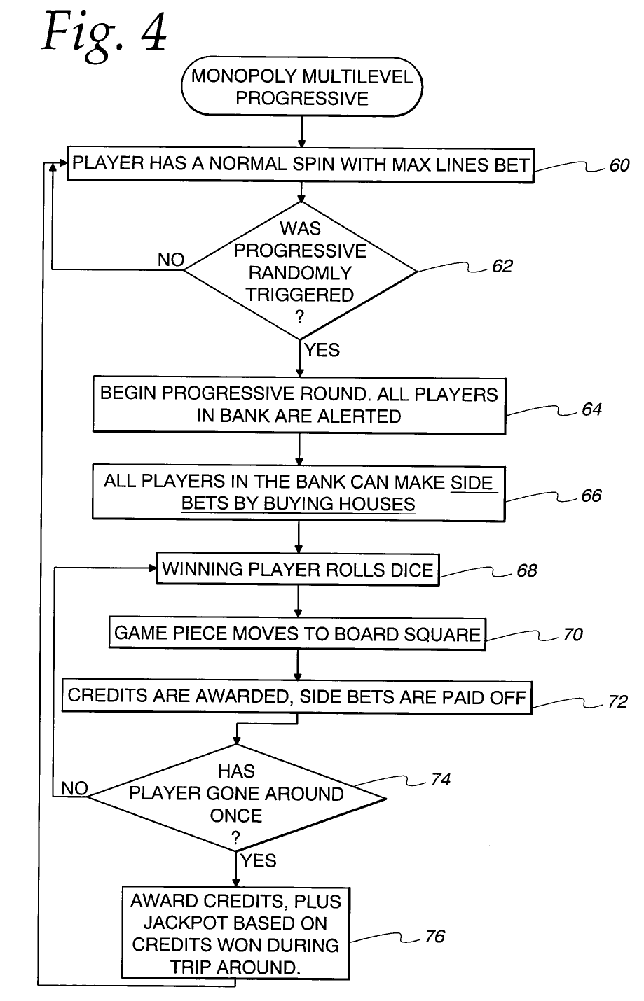

While the gaming machine 10 of FIGS. 1 and 2 has been described with respect to providing a player a basic game and a bonus game, the gaming machine 10 can be connected to a progressive game to which several gaming machines are linked. This gaming network and, in particular, the novel side wagering feature that can be activated by the player of the gaming machine 10 will be described below with reference to FIGS. 3-7.

Referring now to FIG. 3, a gaming system 28 of gaming machines 10a, 10b, 10c, 10d is shown. The four gaming machines 10a, 10b, 10c, 10d are of the type described above in relation to FIGS. 1 and 2. The four gaming machines 10a, 10b, 10c, 10d are interconnected and included under signage 30. The signage 30 includes a game screen 32 for displaying the progressive game which, in this embodiment, is the MONOPOLY ONCE AROUND™ game, and at least one jackpot screen 34 displaying a plurality of dollar amounts for a multi-level progressive game. In this embodiment, there are three dollar amount levels: a Mini Jackpot, a Maxi Jackpot, and a Mega Jackpot. In other embodiments, there may be any number of progressive jackpots.

The signage 30 includes a signage controller 36 that is connected to each of the four gaming machines 10a, 10b, 10c, 10d. The signage controller 36 transmits information to and receives information from the CPU 16 (FIG. 2) in each of the four gaming machines 10a, 10b, 10c, 10d throughout the game. The gaming system 28 allows for various aspects of the gaming machines 10a, 10b, 10c, 10d, such as playing progressive games to be controlled through the signage controller 36 in the signage 30. Thus, all of the gaming machines 10a, 10b, 10c, 10d are linked to the progressive game.

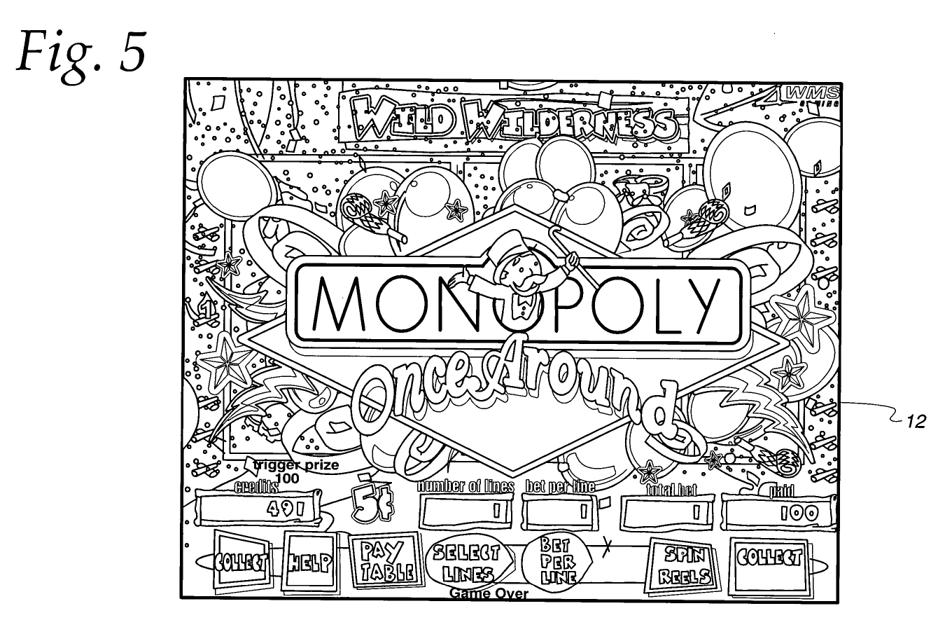

Turning now to FIG. 4, the operation of the progressive game of the gaming system 28 will be described. Reference to FIGS. 5-8 will be made to best describe this operation. In step 60, a player at the gaming machine 10 begins a game by any conventional method (e.g., inserting coins or using credits). Each gaming machine 10a, 10b, 10c, 10d has a basic game that involves a player choosing a number of paylines to play and choosing a wager to place on each payline. In some embodiments, there are a maximum of nine paylines. After choosing how many paylines to play, the player selects how many credits (e.g., 1-5) to wager on each payline. Any player who plays the maximum number of paylines—in the case of the WHO DUNNIT™ gaming machine 10, nine paylines—is eligible to be invited to play in the progressive game. At step 62, it is determined if the progressive game has been randomly triggered by the CPU 16 of the gaming machine 10. This happens when a start progressive outcome, e.g, a combination of jackpot signals, occurs on the screen. If the progressive outcome is not reached, then the gaming machine 10 continues to operate normally. Thus, the player continues to choose the wager amount for each line, spins the reels, and any pay out or bonus games are played normally. Once the game ends, the player is either paid out or more coins/credits are requested for another game.

If, at step 62, one of the gaming machines 10a—which will be referred to as the progressive play gaming machine 10a—has been selected for the progressive game, the basic game initially continues as normal, with the player playing the basic game and any bonus games. The CPU 16 of the progressive play gaming machine 10a sends a signal to the signage controller 36 that the progressive game has been activated. After the basic game and bonus game have finished, at step 64, the player is notified that the progressive game has been triggered (as shown in FIG. 5).

In this embodiment, the progressive game is the MONOPOLY ONCE AROUND™ game, which has a board game (e.g., MONOPOLY) theme and is implemented on the game screen 32 and video display 12 of all of the gaming machines 10a, 10b, 10c, 10d. The board game defines a plurality of stations or squares about a game board traversable by a game token, or token “identifier” indicating the position of a token, or player. For example, in one embodiment, a token “identifier” comprises an illuminated station of the game screen 32 indicating the position of a token. Hereinafter, references to displaying the position of a token, or player, shall be understood to mean the display of either an actual game token or a token identifier on a game board or portion thereof.

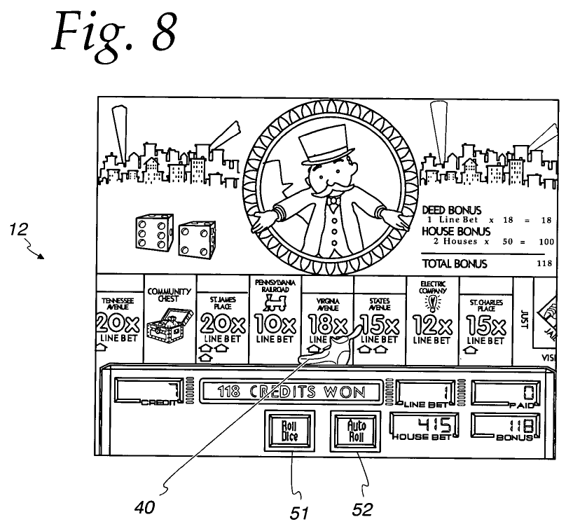

When the player enters the progressive game at step 64, the video display 12 of the progressive play gaming machine 10a instructs the player to select a token 40 (shown as a “SHOE” in FIGS. 7 and 8). In the MONOPOLY ONCE AROUND™ game, a screen may be displayed that shows an animated Rich Uncle Pennybags symbol above a selection of MONOPOLY tokens 40 (e.g., “CAR,” “DOG,” “HORSE,” “SHOE” and “HAT”), and the player is prompted to select one of the game tokens 40. Such a method and others are disclosed in U.S. Pat. No. 6,315,660, which is incorporated herein by reference in its entirety.

Also at step 64, the signage controller 36 sends a side wager inquiry signal that notifies the players at other gaming machines 10b, 10c, 10d in the system 28—hereinafter referred to as the side wager gaming machines 10b, 10c, 10d—that someone is entering the progressive game.

Then, at step 66, a screen is displayed on the video display 12 of the side wager gaming machines 10b, 10c, 10d, giving the other players the opportunity to make side wagers on the stations of the game board which the player predicts will be landed on during the progressive game. The side wagerers are given a particular amount of time (e.g., 30 seconds) to make any side wagers. The time to make a side wager may be counted down by a clock on the display 12 of the side wager gaming machines 10b, 10c, 10d. The increments of the side wagers which may be made on the various stations may be varied according to the game program. For example, in the MONOPOLY ONCE AROUND progressive game, the player has the opportunity to “build” houses (make side wagers) on the properties of the MONOPOLY board which the player predicts will be landed on during the progressive game. The amount of the side wager corresponds to the “cost” of the houses built on the various properties, which generally varies according to the property selected.

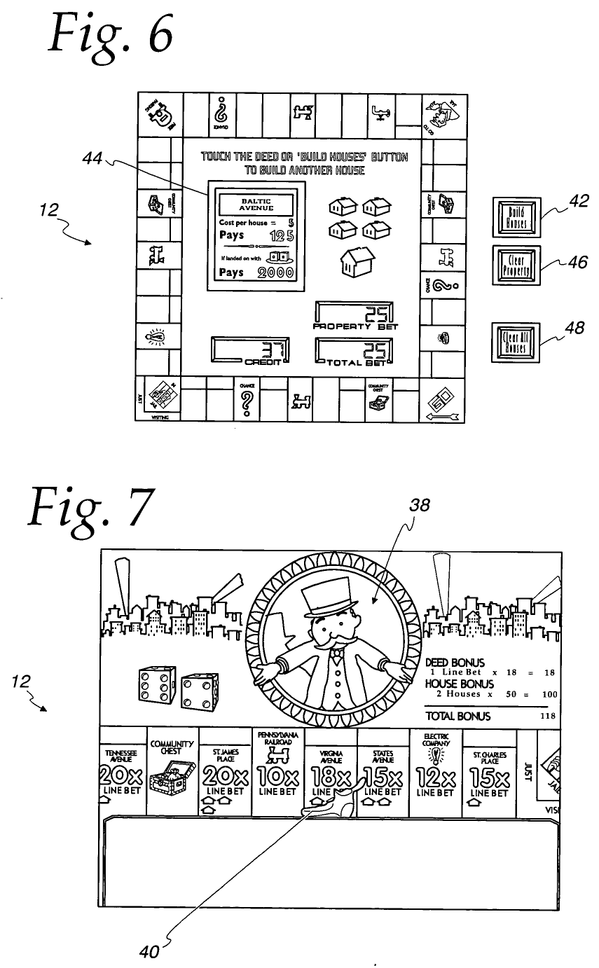

While still at step 66, and after the selection of a property, the signage controller 36 operates to display a property deed 44 (FIG. 6) corresponding to the selected property on the video display 12 of whichever side wager gaming machine 10b, 10c, 10d that is making the wager. In FIG. 6, the property deed shown on the video display 12 of the side wager gaming machines 10b, 10c, 10d is “Baltic Avenue,” thus indicating that the player has elected to build houses on Baltic Avenue. More specifically, the player has identified the “Baltic Avenue” station as a predicted landing position of the token 40. The player builds houses on the selected property by any number of methods, including touching the deed 44 or touching a specific key 42. The cost of the houses may vary depending on the property, such as disclosed in U.S. Pat. No. 6,315,660, which was incorporated by reference above.

While still at step 66, the cost of the houses is subtracted from the credits previously earned or paid into the side wager gaming machine 10b, 10c, 10d by the player. In one embodiment, the player may insert coins or bills into the side wager gaming machine 10b, 10c, 10d at any time during display of the screen shown in FIG. 6 to increase the credits available for building houses. Various keys 46, 48 are provided to allow the players to clear their side wagers should they desire to do so before the beginning of the progressive game. Once the side wagers are made, a side wager response signal is transmitted from the side wager gaming machine 10b, 10c, 10d to the signage controller 36 indicating that the side wager has been made.

Also occurring at step 66, the video display 12 displays a number of house and hotel icons corresponding to the number of houses built on each selected property. In FIG. 6, for example, the video display 12 shows four green house icons and a red hotel icon represents the fifth wager placed on Baltic Avenue. The displayed property deed 44 identifies the cost per house (e.g., credits for Baltic Avenue) and the pay value of landing on the property (e.g., 125 credits for Baltic Avenue, with five houses).

At step 68, once the player of the progressive play gaming machine 10a (FIG. 3) selects a token 40 and all side wagers have been placed, the signage controller 36 s displays a portion of the game board on the video display 12 of all of the gaming machines 10a, 10b, 10c, 10d with the selected token 40 on a starting station of the game board. The signage controller 36 also illuminates the starting station on the game screen 32. For example, in the MONOPOLY ONCE AROUND™ game, the starting station is the “GO” square. The signage controller 36 then randomly selects an integer movement value defining a number of stations or steps which the token 40 is to be moved from the GO square.

In one embodiment, the player “rolls” a pair of dice 49 (FIG. 3) by touching a “Roll Dice” key 50 or “Auto Roll” key 52 on the video display 12 of the progressive play gaming machine 10a. At step 70, token 40 (FIGS. 7 and 8) is advanced across the game board according to the roll of the dice. On the game screen 32 (FIG. 3), movement is illustrated by the illumination, in step-wise fashion, of the appropriate stations (squares) on the game board (e.g., MONOPOLY board) from the previous position to the position determined by the roll of dice. On the video display 12 of the gaming machines 10a, 10b, 10c, 10d, movement is illustrated by the selected game token (e.g., “SHOE”) moving, one space at a time, a corresponding number of spaces on a scrolling portion of the game board. The landing of the token 40 on a particular square or station of the game board constitutes an event in the progressive game.

At step 72, after each roll, the player of the progressive game machine 10a is awarded a point amount that corresponds to the square. In the MONOPOLY ONCE AROUND™ game, if the token 40 lands on a “Chance” or “Community Chest” station (square) during the progressive game, the player playing the progressive game receives an award of a fixed number of points (e.g., “BANK ERROR IN YOUR FAVOR, 100 points), or they can move the player to a new space (e.g., GO BACK THREE SPACES). If the token 40 lands on a property, various points are awarded to the player. In some embodiments, the points awarded may be dependent on the value of the property, as described in U.S. Pat. No. 6,315,660.

Then, at step 72, the signage controller 36 compares the event to the position(s) wagered on by the side wager gaming machines 10b, 10c, 10d and, if the event matches any of the position(s) wagered on, the player who made the side wager is paid an amount of coins or credits, as appropriate, corresponding to the cost of building the house(s) on that property.

Next, at step 74, the signage controller 36 determines if the player has moved s once around the entire board. If the answer is “no,” the program returns to step 68 and the dice is rolled, creating a new event. If the answer is “yes,” then the progressive game has ended and the program moves to step 76 and awards credits to the player of the progressive game.

In a preferred embodiment, at step 76, the payout amount that the progressive game player wins is dependent upon the amount of points that were earned. In some embodiments, the progressive game may comprise multiple jackpots of varying amounts. The more points that the player accumulates during the game, the more credits or money that is paid to the player at the end. As shown in FIG. 3, the gaming system 28 has three payouts, or levels: a mini progressive, a maxi progressive, and a mega progressive. The mini progressive pays out when a player earns between 0 and 499 points during the progressive game, the maxi progressive pays out to players who have earned between 500 and 999 points, and the mega progressive only pays out to players who earn more than 1000 points during the progressive game.

Once one of the levels of a progressive game has been paid out, that level resets itself to the base amount. The other progressives that did not pay out keep increasing until someone wins that progressive jackpot. The progressive jackpots are created by a base amount being put into the pot (e.g., $1,000 for the mini, $3,000 for the maxi, and $5,000 for the mega). Then, every time one of the gaming machines 10a, 10b, 10c, 10d in the system 28 is played, a percentage of the amount wagered is placed into each of the progressives. In some embodiments, 1% may go to the mini progressive, ½% to the maxi progressive, and ¼% to the mega progressive. Because the maxi progressive and the mega progressive payouts less often than the mini progressive, less money needs to go to fund these progressives.

After the credits are all awarded and the progressive has been reset, the program goes back to step 60, with a player playing the maximum number of paylines on the machine.

In another embodiment, the present invention may operate to allow other players to make side wagers when one player has reached any special gaming session. The special gaming session is any game other than the basic game depicted in FIG. 1. For example, the special gaming session may be a bonus game or a progressive game.

In some embodiments, only the side wager gaming machine 10b, 10c, 10d displays the wager made. A screen displaying the game board may appear on the machine with houses placed on the property on which the player wagered. In other embodiments, the side wagers may be displayed on the game screen 32, with different color houses representing the different players. In either embodiment, multiple players can place side wagers on the same property. For example, two different players can each place five houses on Baltic Avenue.

In an alternative embodiment, the person playing the progressive game can also make side wagers on the various events of the game. The progressive play gaming machine 10a would then perform all of the functions described above with respect to the side wager gaming machines 10b, 10c, 10d. The display 12 in FIG. 8 would then also depict the side wagers placed by the person playing the progressive gaming machine 10a.

In some embodiments, the amount of points awarded for the “Chance” or “Community Chest” cards is dependent on the amount wagered by the player per each payline in the basic game. A player who wagered the minimum amount per each payline will receive fewer points than a player who wagers the maximum amount per each payline, even if they draw the same card. For example, the card “Grand Opera Opening” has a payout of 9 credits. In this embodiment, that may be the payout for someone who wagered 1 out of a possible 5 credits. For someone who wagered 5 credits, the payout may be 45 credits. Also, the card marked “Go Back Three Spaces” may have multiple space numbers depending on the amount wagered. For example, if only 1 credit is wagered, the card may read “Go Back Two Spaces,” but if the player wagered the maximum amount, the card may read “Go Back Five Spaces,” thus giving that player more chances to land on property and earn more points.

In another alternative embodiment, the side wager gaming machines 10b, 10c, 10d are offered the chance to place a wager on what the outcome of the progressive game will be. In other words, the side wager gaming machines 10b, 10c, 10d can send a side wager response signal placing a wager on whether the player of the progressive play gaming machine 10a will win the mini jackpot, the maxi jackpot, or the mega jackpot. The side wager gaming machines 10b, 10c, 10d will be credited as described above if the predicted outcome matches the outcome of the progressive game.

In another alternative embodiment, at step 62 in FIG. 4, it is the signage controller 36, not the CPU 16, that randomly starts the progressive game. In this embodiment, the signage controller 36 sends a signal to the CPU 16 of the next gaming machine 10 that places a wager that the progressive game has been triggered. The rest of the game proceeds as described above.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

1. A method for allowing players at a plurality of gaming terminals to place side wagers, the method comprising:
conducting wagering games on the plurality of gaming terminals;
achieving a progressive game at a first one of the plurality of gaming terminals;
in response to achieving the progressive game, sending a side wager inquiry signal to a second one of the plurality of gaming terminals indicating the achievement of the progressive game; and
in response to receiving the side wager inquiry signal, displaying a communication to a player of the second one of the plurality of gaming terminals inquiring whether the player desires to make a side wager on an event that may occur in the progressive game.

2. The method of claim 1, further comprising crediting the second one of the plurality of gaming terminals with a payout amount corresponding to the side wager at the end of the progressive game.

3. The method of claim 1, wherein the event relates to rolling dice.

4. The method of claim 1, wherein the event is a particular outcome of the progressive game.

5. The method of claim 1, further comprising receiving a side wager response signal from the second one of the plurality of gaming terminals indicating that a side wager has been made.

6. The method of claim 5, further comprising crediting the second one of the plurality of gaming terminals a predetermined amount if the event occurs in the progressive game.

7. The method of claim 1, wherein the step of sending is performed by a signage controller in signage located above and coupled to the plurality of gaming terminals.

8. A method for allowing players at a plurality of gaming terminals to place side wagers, the method comprising:
conducting a wagering game on the plurality of gaming terminals;
achieving a special gaming session at a first one of the plurality of gaming terminals;
in response to the achieving, transmitting a side wager inquiry signal to a second one of the plurality of gaming terminals; and
in response to the transmitting, transmitting a side wager response signal from the second one of the plurality of gaming terminals.

9. The method of claim 8, wherein the conducting step comprises choosing at least one of a plurality of paylines to play and choosing a wager amount for each of the plurality of paylines chosen.

10. The method of claim 9, wherein the achieving step only occurs if all of the plurality of paylines are chosen.

11. The method of claim 8, wherein the special gaming session is a progressive game.

12. The method of claim 8, wherein the special gaming session is a bonus game.

13. The method of claim 8, wherein the achieving step includes selecting the first one of the plurality of gaming terminals to enter the progressive game, the selecting being performed by a controller in the first one of the plurality of gaming terminals.

14. A gaming system including a plurality of interconnected gaming terminals, the system comprising:
a first one of the plurality of interconnected gaming terminals for playing a basic game and a special gaming session randomly achieved after the basic game; and
a second one of the plurality of interconnected gaming terminals placing a side wager on an event that may occur in the special gaming session, the second one of the plurality of interconnected gaming terminals including an input mechanism receiving a side wager input in response to the special gaming session being achieved at the first one of the plurality of interconnected gaming terminals.

15. The system of claim 14, wherein the special gaming session is a progressive game and further comprising signage located above and coupled to the plurality of interconnected gaming terminals, the signage displaying the progressive game.

16. The system of claim 15, wherein the signage includes a signage controller for controlling an outcome of the progressive game on the first one of the plurality of interconnected gaming terminals.

17. The system of claim 16, wherein each of the plurality of interconnected gaming terminals includes a gaming terminal controller, the gaming terminal controller being in communication with the signage controller.

18. The system of claim 14, wherein the first one and the second one of the plurality of interconnected gaming terminals are identical machines.

19. A gaming system comprising:
a plurality of interconnected gaming terminals for conducting wagering games, a first one of the plurality of interconnected gaming terminals receiving a side wager inquiry signal in response to a second one of the plurality of interconnected gaming terminals achieving a special gaming session, the side wager inquiry signal causing a side wager inquiry to be displayed to a player of the first one of the plurality of interconnected gaming terminals.

20. The system of claim 19, further comprising signage located above the plurality of interconnected gaming terminals and including a signage controller, the signage controller transmitting the side wager inquiry signal to the first one of the plurality of interconnected gaming terminals.

21. The system of claim 20, wherein the first one of the plurality of interconnected gaming terminals transmits a side wager response signal to the signage controller, the side wager response signal corresponding to a side wager on an event that may occur in the special gaming session to be played by the second one of the plurality of interconnected gaming terminals.

22. The system of claim 21, wherein the signage controller conducts the special gaming session and awards credits to players of the plurality of interconnected gaming terminals if winning outcomes are achieved.

23. The system of claim 19, wherein the special gaming session is a progressive game.

24. The system of claim 23, wherein the player of the second one of the plurality of interconnected gaming terminals participating in the progressive game at least achieves a first payout level at the end of the progressive game.

25. The system of claim 24, wherein the player of the second one of the plurality of interconnected gaming terminals participating in the progressive game may achieve other payout levels greater than the first payout level, the other payout levels being awarded depending on the outcome of the progressive game.

26. The system of claim 19, wherein the side wager is a prediction of whether a player will land a game piece on a certain location of a board game.

27. A gaming system, the system comprising:
a plurality of gaming terminals for conducting wagering games, a first one of the plurality of gaming terminals capable of making a side wager on an event that may occur in a progressive game to be played on a second one of the plurality of gaming terminals; and
signage located above and coupled to the plurality of gaming terminals, the signage displaying the progressive game that is played from the second one of the plurality of gaming terminals and the event on which the side wager is made at the first one of the plurality of gaming terminals.

28. The system of claim 27, wherein the signage includes a signage controller, the signage controller transmitting and receiving signals from the plurality of gaming terminals.

29. The system of claim 28, wherein the signage controller transmits a side wager inquiry signal to the first one of the plurality of gaming terminals, the side wager inquiry signal causing a side wager invitation to be displayed on a display of the first one of the plurality of gaming terminals.

30. The system of claim 27, wherein the first one of the plurality of gaming terminals places a side wager on an event of the progressive game by predicting the particular event.

31. The system of claim 27, wherein the progressive game has a board game theme and the side wager is a prediction of whether a player will land a game piece on a certain location of a board game.

32. A gaming system for playing a progressive game, comprising:
a plurality of gaming terminals for conducting wagering games;
signage located above and connected to the plurality of gaming terminals for conducting a progressive wagering game for players of the plurality of gaming terminals, the signage including a local controller for randomly selecting a progressive game outcome of the progressive wagering game, the progressive game outcome being displayed on the signage.

33. The system of claim 32, wherein the local controller communicates the progressive game outcome to the plurality of gaming terminals.

34. The system of claim 32, wherein each of the plurality of gaming terminals includes a plurality of paylines for conducting a slot machine game.

35. The system of claim 34, wherein entry to the progressive wagering game is randomly awarded only to players who place wagers on all of the plurality of paylines.

36. The system of claim 32, wherein the local controller randomly selects one of the plurality of gaming terminals to enter the progressive game.

37. The system of claim 32, wherein the progressive game outcome depends on a wager amount chosen by players during the wagering games.

38. The system of claim 32, wherein the progressive game is a multi-level progressive game, the multi-level progressive game having multiple levels of payouts.

39. The system of claim 38, wherein a player of the multi-level progressive game accumulates points and is awarded a jackpot at one of the multiple levels of payouts depending on the number of points accumulated.
